(19) United States
(12) Patent Application Publication
(10) Pub. No.: US 2020/0394724 A1
(43) Pub. Date: Dec. 17, 2020

(54) PERSONA BASED INTERVENTION

(71) Applicant: Conduent Business Services, LLC, Florham Park, NJ (US)

(72) Inventors: Harshit AGRAWAL, Lucknow (IN); Jayati BANDYOPADHYAY, Bengaluru (IN); Nupur LABH, Varthur (IN); Sandya Srivilliputtur MANNARSWAMY, Bangalore (IN); Snigdha PETLURU, Bengaluru (IN)

(73) Assignee: Conduent Business Services, LLC, Florham Park, NJ (US)

(21) Appl. No.: 16/440,269

(22) Filed: Jun. 13, 2019

(51) Int. Cl. G06Q 50/00; G06F 16/28; G06Q 30/02

(52) U.S. Cl. CPC G06Q 50/01; G06Q 30/0282; G06F 16/285

(57) ABSTRACT

A method of selecting an intervention includes, based on user content submitted to a platform, determining whether the content includes objectionable content. Based on the objectionable content, a content persona classification is associated with the objectionable content. Based on the content persona classification, an intervention is selected. The objectionable content may include, for example, content that has one or more characterizations as: subjective, misaligned, trigger, misguided, expressive, non-owner, offensive, prohibited, trigger product, trigger description, expired/invalid, and/or otherwise objectionable.

### TECHNICAL BACKGROUND

Virtual hooliganism and misbehavior on online services and content publishing platforms appears to be increasing. Mainstream social networking platforms are seeking to solve problems associated with content moderation. However, moderating content requires a significant amount of resources and technology. While automated and semi-automated moderation strategies and tools are improving, offenders find means to bypass conventionally programmed logic. In addition, employing agencies or hiring human resources for manual moderation is expensive. Another problem with human moderation is the psychological impact that objectionable content has on moderators.

### OVERVIEW

In an embodiment, a method of selecting an intervention includes, based on user content submitted to a platform, determining whether the content includes objectionable content. The method further includes, based on the objectionable content, associating a content persona classification with the objectionable content. The method further includes, based on the content persona classification, selecting an intervention.

In an embodiment, a method includes receiving user content submitted to a platform. The method further includes determining whether the user content is associated with a product or is associated with a review. The method further includes associating a persona classification with the user content. The method further includes determining whether the user content includes objectionable content. The method further includes, based on the persona classification, the objectionable content, and whether the user content is associated with a product, selecting an intervention.

In an embodiment, a method includes receiving user content associated with a product. The method further includes, based on the user content, associating, with one or more of a set of classifications, the user content based on at least a set of defined personas, objectionability, and validity. The method further includes, based on the one or more of the set of classifications that the user content is associated with, selecting an intervention.

### BRIEF DESCRIPTION OF THE DRAWINGS

FIG. 1 is a block diagram illustrating a persona based intervention system.

FIG. 2 is a flowchart illustrating a method of selecting an intervention.

FIG. 3 is a flowchart illustrating product/review based selection of an intervention.

FIG. 4 is a flowchart illustrating content persona based intervention selection.

FIG. 5 is a flowchart illustrating an intervention method.

FIG. 6 illustrates a processing node.

### DETAILED DESCRIPTION

Some online platforms and organizations struggle to police input received as reviews for inaccurate and/or offensive content. Some have shut down commenting sections which harms the user experience because these reviews/comments can be a crucial decision-making factor for members within these online communities. Shutting down discourse does not just stifle the creation of an engaged social community around the product or service, it also makes honest participants within the community feel disenfranchised.

In an embodiment, interventions are made after the creation of offensive content. Distinct personas of users, and content characteristics may be identified that lead to the development or reinforcement of these personas. Intervention strategies that are personalized based on the channel of interaction as well as the mapped persona are also identified. By identifying and deploying individualized intervention strategies that work best for a particular persona, users are encouraged to engage in corrective behaviors.

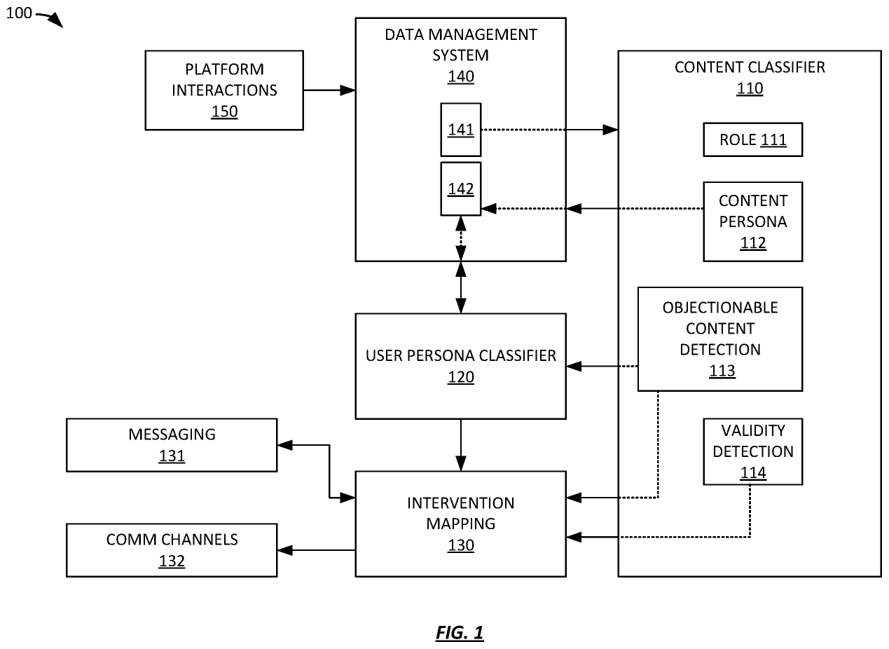

FIG. 1 is a block diagram illustrating a persona based intervention system. In FIG. 1, intervention system 100 comprises content classifier 110, user persona classifier 120, intervention mapping system 130, messaging module 131, and intervention communication channels 132, data management system 140, and platform interactions 150. Content classifier 110 includes role classifier 111, content persona classifier 112, objectionable content detection 113, and validity detection 114. Data management system 140 includes interaction data 141 and persona data 142.

Platform interactions 150 is operatively coupled to data management system 140 (and interaction data 141, in particular.) Data management system 140 is operatively coupled to content classifier 110 and user persona classifier 120. Data management system 140 is operatively coupled to content classifier 110 to provide at least customer information data and associated platform interaction data 141 to content classifier 110. Content classifier 110 is operatively coupled to data management system 140, user persona classifier 120, and intervention mapping system 130. Intervention mapping system 130 is operatively coupled to messaging module 131 and intervention communication channels 132.

Data management system 140 serves as a central database linked a platform that contains information about the customer and the customers platform interactions 150. Data management system 140 may collect and/or store, for example, the following kinds of data: (1) clickstream data—all interactions that customers engage in with the platform or companion applications to on a daily basis; (2) user data—insights obtained about the user about their demographics, preferences, interests and patterns; (3) product data—on selling platforms, information about the product and corresponding sellers; and/or (4) persona data—the classified personas associated with content and/or platform interactions.

Role classifier 111 of content classifier 110 may use structural syntax to determine whether the content or platform interaction (e.g., from data management system 140) is a product listing or a review of a product listing. If it is a review, then the content persona classifier 112 would be provided the content or platform interaction in order to associate a persona with the content. If the review has characteristics that can be attributed to a persona's characteristics, then the content is classified and associated with a persona and the identified persona is shared with the user persona classification module 120. If the content is a product listing, then a persona is not associated with the content.

Objectionable content detection 113 may use a set of Natural Language Processing (NLP) algorithms to identify distinct forms of objectionable content. A magnitude or intensity of the objectionable content is also associated with the content. Validity detection 114 processes the product listing and reviews to determine whether the content includes indicators of invalid content such as misaligned subject (geography, content, audience), expired content, and/or prohibited content. When multiple indicators of invalid content are associated with the content, a priority for intervention is increased.

User persona classifier 120 may classify a reviewer into, for example, one or more of the following reviewer personas: subjective, objective, misaligned, trigger, misguided, expressive, high-returner, non-owner, and offensive. A subjective reviewer persona may be selected when the review is highly descriptive in nature but does not address a real issue. An objective reviewer persona may be selected when the review is non-descriptive in nature and identifies a real issue.

A misaligned reviewer persona may be selected when it is determined there is one or more of a review-geographical misalignment, a review-product misalignment, and/or a review-seller misalignment. A review-geographical misalignment may be selected when, for example, a review states something about a product and that statement does not hold true in the geographical area associated with the reviewer and/or review, or does not hold true for the geographical areas that the product is intended for (e.g., right-hand car steering wheels in the United States.) A review-product misalignment may be selected when, for example, the review is posted to a different product than the review addresses (i.e., posted to the wrong product listing.) A review-seller misalignment may be selected when, for example, the review addresses the correct product but was posted to the wrong seller's profile and/or listing.

A trigger reviewer persona may be selected when, for example, the review itself is not deemed objectionable, has indications that it will lead to backlash from other reviewers due to how the review is framed, and/or other subtleties. For example, a review that states “ . . . only dogs would buy this product . . . ” when it is not a pet related product may trigger a response from those who liked the product and understand the statement as equivalent to being called a ‘dog.’

A misguided reviewer persona may be selected when, for example, there is a mismatch between a rating score and the review comment. For example, the review may state that this is a ‘great product, everyone should buy one . . . ” but the reviewer only gave the product a “1-star” out of 5 rating. An expressive reviewer persona may be selected when, for example, the review is overly expressive and verbal. A high-returner reviewer persona may be selected when, for example, the reviewer often tries then returns products. A non-owner reviewer persona may be selected when, for example, it is determined the reviewer has not bought the specific product from the platform they are posting the review on. An offensive reviewer persona may be selected when, for example, the review contains hate speech or other offensive material/language.

User persona classifier 120 may classify a seller into, for example, one or more of the following seller personas: misaligned, prohibited, trigger product, trigger description, expired/invalid, objectionable, and offensive. A misaligned seller persona may be selected when, for example, it is determined there is one or more of an item-geographical misalignment, an item-category misalignment, an item-content misalignment, and/or a description-audience misalignment.

An item-geographical misalignment may be selected when, for example, the item/product is marked as being permitted to be sold into a geography where it is not allowed to be sold. An item-category misalignment may be selected when, for example, the item/product has been placed into the wrong category (e.g., eating utensils placed into the ‘cleaning supplies’ category.) An item-content misalignment may be selected when, for example, the product description does not match the item/product it is associated with (e.g., the description for a ‘box of rubber bands’ talks about ‘decorative stone tile’.) A description-audience misalignment may be selected when, for example, the item/product description contains content that might not be suitable for the audience the product is restricted to.

A prohibited seller persona may be selected when, for example, an attempt to list a product/item that is prohibited (according to platform policies) is made. A seller trigger product persona may be selected when, for example, a product has the possibility of leading to trigger comments, but which itself cannot be banned. For example, if a product has certain side-effects upon consumption, and the seller hasn't made those side-effects clear. The existence of those undisclosed side effects could lead to a backlash.

A seller trigger description persona may be selected when, for example, the product description is determined to have a likelihood of leading to backlash in the reviews of the product. For example, a general use product with a description that includes ‘ . . . this product is great for men . . . ” may lead to reaction by women using the product. An expired/invalid product persona may be selected when, for example, the item/product/price has expired or is otherwise no longer available.

An objectionable description persona may be selected when, for example, the item/product description includes objectionable language. An offensive description persona may be selected when, for example, the item/product description includes hate speech.

Intervention mapping system 130 selects messaging module 131 to be provided to the user (i.e., reviewer or seller) via a communication channel 132 based on the user persona classification provided by user persona classifier 120. Intervention mapping system 130 selects messaging module 131 to be provided to the user (i.e., reviewer or seller) and selects the communication channel 132 based further on inputs from objectionable content detection 113 and validity detection 114. In particular, communication channels 132 are selected from the general groups of: (1) on-platform notification, and (2) off-platform channels. The on-platform notifications may include, but are not limited to: notification icon, direct messaging chat (e.g., chatbot), a popup with a required action, and/or a popup without a required action. The off-platform notifications may include, but are not limited to: SMS (i.e., text message), e-mail, and/or voice call. The channel 132 selected may be based on the persona selected by user persona classifier 120. Table 1 details an example persona to channel selection mapping.

TABLE 1

| Selected Persona | On-platform channel | Off-platform channel |
|---|---|---|
| objective reviewer | Notification icon | SMS |
| subjective reviewer | Chatbot | Email |
| misaligned reviewer | Chatbot | Email |
| trigger reviewer | Popup with required action | Voice call and/or email |
| misguided reviewer | Chatbot | Email |
| expressive reviewer | Chatbot | Email |
| high-returner reviewer | Chatbot | Voice call and/or email |
| non-owner reviewer | Notification icon | SMS |
| offensive reviewer | Popup without required action | Email |
| prohibited seller | Popup without required action | Email |
| misaligned seller | Chatbot | Email |
| seller trigger product | Popup with required action | Voice call and/or email |
| seller trigger description | Popup with required action | Voice call and/or email |
| expired/invalid product | Popup without required action | Email |
| objectionable description | Popup without required action | Email |
| offensive description | Popup without required action | Email |

A popup with a required action is an on-platform intervention that a user has to act upon to in order to proceed further in the platform. This messaging strategy may be used for a highly sensitive offense, or where an action necessarily needs to be taken on the user's end. A popup with a required action may also be used for trigger reviews and trigger product descriptions. The platform cannot remove the trigger reviewer persona content because the content itself has nothing overtly offensive, because removing the trigger reviewer persona content would typically be against the platform's policies. Similarly, for trigger products/descriptions a mandatory action is required on the seller's end to ensure the seller has made the product/description as ‘trigger proof’ as possible.

A popup without a required action is an intervention that a user has to acknowledge to in order to proceed further in the platform. Typically, when a popup without required action is selected, the platform has already taken an action on its own, but brings this action to the user's notice so that the user acknowledges the action, learns more about the offense, and provides an option for the user to raise an exception. A popup without a required action may be used when a seller uploads a prohibited product, or an invalid/expired product. A popup without a required action may also be used in cases of offensive (hate speech) detection in product description or review content.

A chatbot may be used for providing guidance so that users may take actions on less time critical issues. For example, when a seller uploads a product in a misaligned category, or a reviewer writes a review of misaligned product, a chatbot assistant can help provide guidance to help correct the mistake. This also helps ensure that the issue has been identified correctly and is dealt with by bringing the issue to the user's notice. A chatbot may be used for a subjective reviewer. For example, the user may be asked to take a survey about the product associated with the review. This survey may help them convert the review into an objective one. A chatbot may be used to make a misguided reviewer aware of the rating system of the platform. A chatbot may be used to lead a frequent returner through a qualitative intercept to understand the frequent returner's pain points (issues) and thus possibly change the frequent returning behavior. A chatbot may be used for an expressive reviewer to make sure that the expressive reviewer really intended (in hindsight) the strong response to a particular product that was initially posted.

A notification may be used more as an acknowledgement than actionable intervention. A notification may be used for an objective reviewer to express appreciation of the objectivity of the review and to reinforce good behavior. A notification may be used for notifying non-owner reviewers that the review will be tagged as a non-owner review to thereby bring their non-owner classification to the notice of the other platform users. An SMS may be used as a notification and may also be used for a reviewer who writes an objective review.

A voice call may be used when the user may need an explanation of a particular offense. This may occur for offense that may not be apparent, or may be highly sensitive (e.g., trigger reviews, trigger products, and trigger descriptions.) A voice call may be used for instances where qualitatively understanding a user's pain point is necessary too (e.g., a frequent returner.)

An email may be selected as a communication channel where actionable items can be sent, but where immediacy is not of concern and ambiguity is not likely to occur. In an embodiment, instances where a chatbot is used will also have an associated email communication. In cases where we use a popup without required action is used, an email may be sent as formal communication. In these cases, the platform may have already taken an action and therefore immediacy is not a priority. An email may be sent (e.g., in addition to a call) as form of a formal communication.

Messaging module 131 generates personalized messages based on the intervention strategy identified and inserts it into a template appropriate to the channel that is identified for intervention. Messaging module 131 chooses and personalizes a messaging template based on the intervention strategy that was selected. The factors that messaging module 131 may consider include, but are not limited to: whether the user a seller or reviewer; whether the user is a new offender or a habitual/repeat offender; the seller's persona classification; the intensity of the identified objectionable content; the type of triggered validation-based criteria and associated priority; and/or, the selected channel of intervention. Messaging module 131 receives the selected channel for the intervention and returns the intervention to intervention mapping module 130 for provision a selected channel 132.

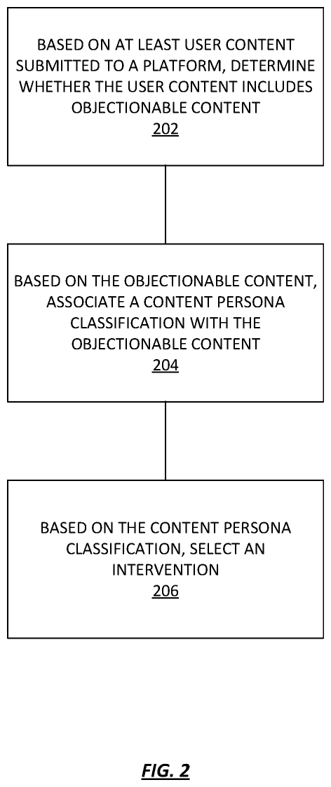

FIG. 2 is a flowchart illustrating a method of selecting an intervention. The steps illustrated in FIG. 2 may be performed by one or more elements of system 100 and/or their components. Based at least on user content submitted to a platform, whether the user content includes objectionable content is determined (202). For example, content classifier 110 (and objectionable content detection and/or validity detection 114, in particular) may determine whether platform interactions 150 from a user that is stored in data management system 140 (and interaction data 141, in particular) includes objectionable content. The objectionable content may include, for example, content that has one or more characterizations as: subjective, misaligned, trigger, misguided, expressive, non-owner, offensive, prohibited, trigger product, trigger description, expired/invalid, and/or otherwise objectionable.

Based on the objectionable content, a content persona classification is associated with the objectionable content (204). For example, content classifier 110 (and content persona classifier, in particular) may, based on the content, associate a persona with the content. If the user is a reviewer, for example, one or more of the following reviewer personas may be associated: subjective, objective, misaligned, trigger, misguided, expressive, high-returner, non-owner, and offensive. If the user is a seller, for example, one or more of the following seller personas may be associated: misaligned, prohibited, trigger product, trigger description, expired/invalid, objectionable, and offensive.

Based on the content persona classification, an intervention is selected (206). For example, based on a user persona selected by user persona classifier 120, which is based on the content persona provided by content persona 112, intervention mapping 130 may select an intervention. The intervention(s) may be, for example, selected from those given in Table 1.

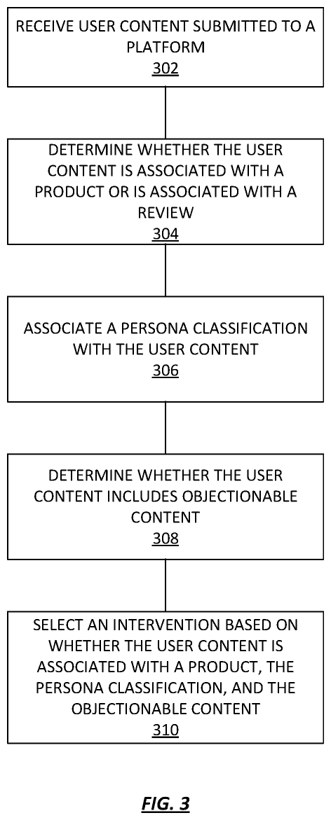

FIG. 3 is a flowchart illustrating product/review based selection of an intervention. The steps illustrated in FIG. 3 may be performed by one or more elements of system 100 and/or their components. User content submitted to a platform is received (302). For example, platform interactions 150 from a user may be received and stored in data management system 140 (and interaction data 141, in particular.)

Whether the user content is associated with a product or is associated with a review is determined (304). For example, role detection 111 may determine whether the content is directed to a product that a different user is selling, or is directed to a product that the user is selling. A persona classification is associated with the user content (306). For example, content classifier 110 (and content persona classifier, in particular) may, based on the content and the role determined in box 304, associate a persona with the content. If the role is determined to be a reviewer, for example, one or more of the following reviewer personas may be associated: subjective, objective, misaligned, trigger, misguided, expressive, high-returner, non-owner, and offensive. If the role is determined to be a seller, for example, one or more of the following seller personas may be associated: misaligned, prohibited, trigger product, trigger description, expired/invalid, objectionable, and offensive.

Whether the user content includes objectionable content is determined (308). For example, content classifier 110 (and objectionable content detection and/or validity detection 114, in particular) may determine whether platform interactions 150 from a user that is stored in data management system 140 (and interaction data 141, in particular) includes objectionable content. The objectionable content may include, for example, content that has one or more characterizations as: subjective, misaligned, trigger, misguided, expressive, non-owner, offensive, prohibited, trigger product, trigger description, expired/invalid, and/or otherwise objectionable.

An intervention is selected based on whether the user content is associated with a product, the persona classification, and the objectionable content (310). For example, based on the determined role, the persona classification, and the objectionable content, intervention mapping 130 may select an intervention. The intervention(s) may be, for example, selected from those given in Table 1.

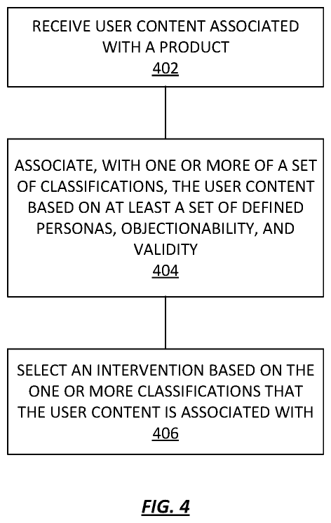

FIG. 4 is a flowchart illustrating content persona based intervention selection. The steps illustrated in FIG. 4 may be performed by one or more elements of system 100 and/or their components. User content associated with a product is received (402). For example, platform interactions 150 from a user may be received and stored in data management system 140 (and interaction data 141, in particular.) These interactions may comprise a product listing and/or description, or a review of a product.

The user content is associated with one or more of a set of classifications based on at least a set of defined personas, objectionability, and validity (404). For example, based on one or more personas selected by content persona classifier 112, the output of objectionable content detection 113, and the output of validity detection 114, user persona classifier may select a classification. This classification may be, for example, selected from the personas given in Table 1.

An intervention is selected based on the one or more classifications that the user content is associated with (406). For example, based on a user persona selected by user persona classifier 120 intervention mapping 130 may select and intervention. The intervention(s) may be, for example, selected from those given in Table 1.

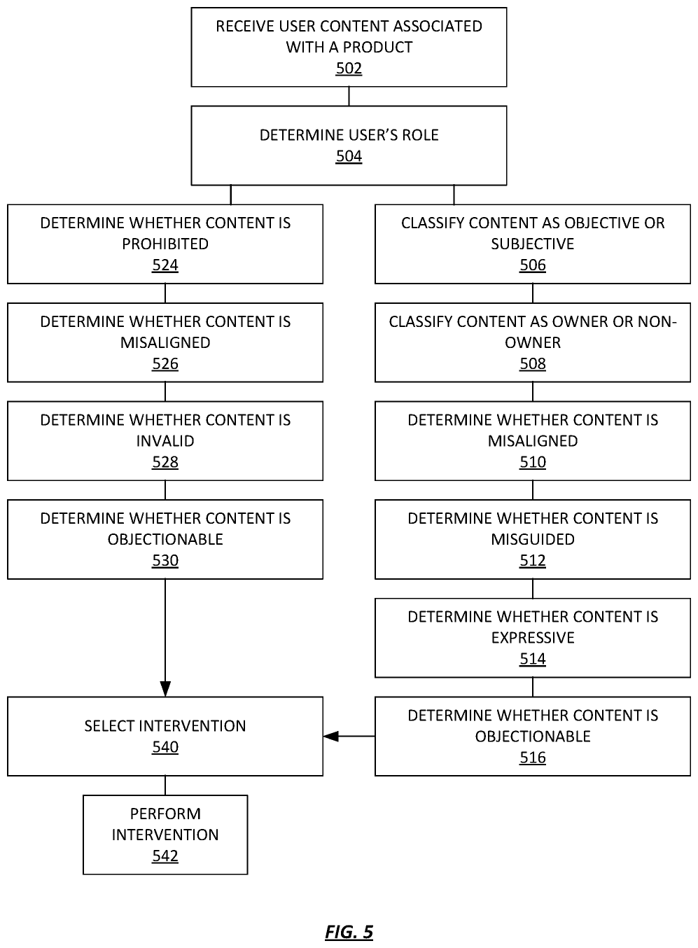

FIG. 5 is a flowchart illustrating an intervention method. The steps illustrated in FIG. 5 may be performed by one or more elements of system 100 and/or their components. User content associated with a product is received (502). For example, platform interactions 150 from a user may be received and stored in data management system 140 (and interaction data 141, in particular.) These interactions may comprise a product listing and/or description, or a review of a product.

The user's role is determined (504). For example, role detection 111 may determine whether the content is directed to a product that a different user is selling (reviewer role), or is directed to a product that the user is selling (seller role). If the content is associated with the reviewer role, then flow proceeds to box 506. If the content is associated with the seller role, then flow proceeds to box 524.

If the content is associated with the reviewer role, then the content is classified as objective or subjective (506). For example, content persona classifier 112 may classify the content as objective or subjective. Example pseudocode for this classification procedure is given in Table 2. Note that TextBlob (referenced in Table 2) is a Python programming language library for processing textual data. It provides a consistent API for diving into common natural language processing (NLP) tasks such as noun phrase extraction, part-of-speech tagging, sentiment analysis, classification (e.g., naive Bayes, decision tree), language translation and detection, tokenization (e.g., splitting text into words and sentences), word and phrase frequencies, parsing, n-grams, word inflection (pluralization and singularization) and lemmatization, and spelling correction.

TABLE 2
For each comment N received:

| | |
|---|---|
| 1. | With TextBlob. identify the sentiment subjectivity S of the comment N |
| 2. | If S > 0, classify comment as Subjective and return. |
| 3. | Else if S < 0, classify comment as Objective and return. |

The content is classified as owner or non-owner (508). For example, content persona classifier 112 may label the content as having been posted by an owner or a non-owner. Example pseudocode for this classification procedure is given in Table 3.

TABLE 3
For each comment N received:

| 1. | Identify user U_{N} and product P associated with the posting of comment N. |
|---|---|
| 2. | From data management system 140, retrieve list of purchases L [P₁, P₂ ... Pₖ] made |
| | by U_{N}. |
| 3. | If P does not exist in L: |

3.1 Label comment as Non Owner comment.
3.2 Return label.

It is determined whether the content is misaligned (510). For example, content persona classifier 112 may label the content as being misaligned as to geography, misaligned as to seller, and/or misaligned as to product. Example pseudocode for this classification procedure is given in Table 4.

TABLE 4
For each comment N received:

| 1. | Retrieve product P associated with the comment N. |
|---|---|
| 2. | From data management system 140, retrieve the geography tag G, current seller |
| | identity S_{c}, seller list S and product description D associated with product P. |
| 3. | Use the Named Entity Recognition module to retrieve list of entities E [E₁, E₂, ... Eₖ] |
| | in comment N. |
| 4. | For each entity Eᵢ in E: |

4.1 If Eᵢ's associated entity tag T is Location:

| | |
|---|---|
| 4.1.1 | If T's geographical coordinates align with the Product's |

geographical tag G:

4.1.1.1 Assign Misaligned Geography as label to

Comment N

4.1.1.2 Return label

4.2 Else if Eᵢ's associated entity tag T is a Name:

| | |
|---|---|
| 4.2.1 | If Eᵢ is in seller list S: |

4.2.1.1 If Eᵢ and current seller identity S_{c} do not match:

| | |
|---|---|
| 4.2.1.1.1 | Assign Misaligned Seller as |

label to Comment N

| | |
|---|---|
| 4.2.1.1.2 | Return label |

4.3 Else if Eᵢ's associated entity tag T is labelled as Other:

| | |
|---|---|
| 4.3.1 | If Eᵢ does not match product description D: |

4.3.1.1 Assign Misaligned Product as label to Comment

N

4.3.1.2 Return label

| | |
|---|---|
| 4.3.2 | Else identify adjectives list A and numeric attributes N |

mapped to Ei:

4.3.2.1 If A and N do not align with product descriptive

parameters D

| | |
|---|---|
| 4.3.2.1.1 | Assign Misaligned Product |

as label to Comment N

| | |
|---|---|
| 4.3.2.1.2 | Return label |

It is determined whether the content is misguided (512). For example, content persona classifier 112 may label the content as being misguided where the rating does not accord with the language in the review. Example pseudocode for this classification procedure is given in Table 5.

TABLE 5
For each comment and rating pair <N, R> received:

| | |
|---|---|
| 1. | Retrieve global minimum and maximum rating possible Rₘᵢₙ and Rₘₐₓ. |
| 2. | Calculate global average rating R_{avg} as (Rₘₐₓ + Rₘᵢₙ)/2. |
| 3. | If R > R_{avg}, classify R_q as positive |
| 4. | Else if R < R_{avg}, classify R_q as negative |
| 5. | Else, classify R_q as neutral |
| 6. | With TextBlob, identify the sentiment polarity P of the comment N |
| 7. | If (P > 0 and R_q is negative) or (P < 0 and R_q is positive): |

7.1 Classify comment rating pair as Misguided and return.

It is determined whether the content is expressive (514). For example, content persona classifier 112 may label the content as being expressive when the review is overly expressive and verbal. Example pseudocode for this classification procedure is given in Table 6.

TABLE 6
For each comment N received:

| | |
|---|---|
| 1. | Tokenize the comment into a list L of words [W₁... Wₖ] |
| 2. | Initiate tokens slang, shout, rep_alphabet, rep_punctuation to 0. |
| 3. | For every word W in list L: |

3.1 If W exists in slang dictionary SlangSD
(http://slangsd.com/data/SlangSD.zip):

| | |
|---|---|
| 3.1.1 | Increment slang |
| 3.1.2 | Classify comment as Expressive. |

3.2 If all letters in W are capitalized and W is not a slang or abbreviation:

| | |
|---|---|
| 3.2.1 | Increment shout |
| 3.2.2 | Classify comment as Expressive. |

3.3 If W has incorrect spelling:

| 3.3.1 | Retrieve closest correctly spelt word W* |
|---|---|
| 3.3.2 | Identify list of extra characters C[c1.. ck] and positions |
| | P[p1...pk]that are included in W that are missing in W* |
| 3.3.3 | For each combination cᵢ, pᵢ: |

3.3.3.1 If character c at position pᵢ + 1 or pᵢ−1 is the

same as cᵢ:

3.3.3.1.1 Increment rep_alphabet
3.3.3.1.2 Classify comment as Expressive.

| 4. | Search N for global matches of punctuations that occur 2 or more times |
|---|---|
| | consequently through the regular expression \([\\\-\/\(\)!″+,′&]{2,})\g |
| 5. | For each match from step 4: |

5.1 Increment rep_punctuation
5.2 Classify comment as Expressive.

| | |
|---|---|
| 6. | If comment is classified as Expressive, return the classification. |

It is determined whether the content is objectionable (516). For example, objectionable content detection 113 may use a set of Natural Language Processing (NLP) algorithms to identify distinct forms of objectionable content—as trigger content. A magnitude or intensity of the objectionable content is also associated with the content. Example pseudocode for this classification procedure is given in Table 7.

TABLE 7
For each comment N received:

| | |
|---|---|
| 1. | Retrieve a list L of collocations [C₁ ... Cₖ] |
| 2. | For every collocation Cᵢ in list L: |

| | |
|---|---|
| 2.1 | If Cᵢ exists in Trigger lookup table T |

| | |
|---|---|
| 2.1.1 | Increment corresponding collocation's |
| | weight in the lookup table T |
| 2.1.2 | Label comment as Trigger comment. |
| 2.1.3 | Return label |

| | |
|---|---|
| 3. | Tokenize the comment into a list L of words [W₁... Wₖ] |
| 4. | For every word Wⱼ in list L: |

```
  4.1 Use a Porter Stemmer to stem word Wᵢto Wᵢ*.
  4.2 If Wᵢ or Wi*exist in Trigger lookup table T:
```

| | |
|---|---|
| 4.2.1 | Increment corresponding collocation's |
| | weight in the lookup table T |
| 4.2.2 | Label comment as Trigger comment. |
| 4.2.3 | Return label |

| | |
|---|---|
| 5. | Retrieve a list L of comment N's threaded or nested comments [N₁ ... Nₚ] |
| 6. | Initiate trigger impact variable to 0 |
| 7. | For every comment Nᵢ in list L: |

```
  7.1 Run the Objectionable Content Detection function.
  7.2 If Nᵢ has objectionable content:
```

| | |
|---|---|
| 7.2.1 | Increment the trigger impact variable |
| 7.2.2 | For each objectionable word Wᵢ in Nᵢ: |

| 7.2.2.1 | Add word Wᵢ to Trigger lookup table T |
|---|---|
| 7.2.2.2 | Find a list L₂ of semantically similar words in |
| | original comment N [W₁... Wₖ] |
| 7.2.2.3 | For each word W in L₂: |

| | |
|---|---|
| 7.2.2.3.1 | Add word W to Trigger |

lookup table T with weight 0.

7.3 If trigger impact is greater than threshold value

| | |
|---|---|
| 7.3.1 | Label comment as Trigger comment. |
| 7.3.2 | Return label. |

After it is determined whether the content is objectionable, flow proceeds to box 540 to select an intervention. Once the user's role is determined in box 504, if the content is associated with the seller role, then flow proceeds to box 524 where it is determined whether the content is prohibited (524). Prohibited content is when, for example, an attempt is made to list a product/item that is prohibited (according to platform policies). It is determined whether the content is misaligned (526). For example, conent persona 112 may classify content as misaligned when, for example, it is determined there is one or more of an item-geographical misalignment, an item-category misalignment, an item-content misalignment, and/or a description-audience misalignment. Example pseudocode for this classification procedure is given in Table 8.

TABLE 8

| | |
|---|---|
| 1. | For each product P: |

| 1.1 | In the CMS, retrieve the geography tag G_{c,} current seller identity S_{c,} seller list |
|---|---|
| | S, product category C_{c}, audience category A_{c} and product description D_{c} |
| | associated with product P. |
| 1.2 | Retrieve a list of accepted geography tags G [G₁, G₂, ... Gₖ], audience tags A |
| | [A₁, A₂, ... Aₖ], associated with product category C_{c}. |
| 1.3 | If G_{c} does not exist in G: |

| | |
|---|---|
| 1.3.1 | Assign Misaligned Geography as label to Product P |
| 1.3.2 | Return label |

| | |
|---|---|
| 1.4 | If A_{c} does not exist in A: |

| | |
|---|---|
| 1.4.1 | Assign Misaligned Audience as label to Product P |
| 1.4.2 | Return label |

| | |
|---|---|
| 1.5 | For each seller Sᵢ in seller list S: |

| 1.5.1 | Retrieve associated product description Dᵢ associated with |
|---|---|
| | product P |
| 1.5.2 | If D_{c}'s semantic similarity with Dᵢ is less than threshold Ø: |

1.5.2.1 Assign Misaligned Content as label to Product P
1.5.2.2 Return label

It is determined whether the content is invalid (528). For example, content classifier 110 (and validity detection 114, in particular) may detect when, for example, the item/product/price has expired or is otherwise no longer available. It is determined whether the content is objectionable (530). For example, objectionable content detection 113 may use a set of Natural Language Processing (NLP) algorithms to identify distinct forms of objectionable content—such as trigger content. A magnitude or intensity of the objectionable content is also associated with the content. Example pseudocode for this classification procedure is given in Table 9.

TABLE 9
For each product P identified:

| | |
|---|---|
| 1. | Retrieve associated product description D. |
| 2. | Retrieve a list L of collocations [C1 ... Ck] associated with D |
| 3. | For every collocation Ci in list L |

3.1 If Ci exists in Trigger lookup table T

| 3.1.1 | Increment corresponding collocation's weight in the lookup |
|---|---|
| | table T |
| 3.1.2 | Label product description as a Trigger. |
| 3.1.3 | Return label |

| | |
|---|---|
| 4. | Tokenize the comment into a list L of words [W1 ... Wk] |
| 5. | For every word Wj in list L: |

5.1 Use a Porter Stemmer to stem word Wi to Wi*.
5.2 If Wi or Wi*exist in Trigger lookup table T:

| 5.2.1 | Increment corresponding collocation's weight in the lookup |
|---|---|
| | table T |
| 5.2.2 | Label product description as a Trigger. |
| 5.2.3 | Return label |

| | |
|---|---|
| 6. | Retrieve a list L of Product P's root or nested comments [N1 ... Np] |
| 7. | Initiate trigger impact variable to 0 |
| 8. | For every comment Ni in list L: |

8.1 Run the Objectionable Content Detection function.
8.2 If Ni has objectionable content:

| | |
|---|---|
| 8.2.1 | Increment the trigger impact variable |
| 8.2.2 | For each objectionable word Wi in Ni: |

8.2.2.1 Add word Wi to Trigger lookup table T
8.2.2.2 Find a list L2 of semantically similar words in

original comment N [W1... Wk]

8.2.2.3 For each word W in L2:

| | |
|---|---|
| 8.2.2.3.1 | Add word W to Trigger |

lookup table T with weight 0.

8.3 If trigger impact is greater than threshold value

| | |
|---|---|
| 8.3.1 | Label product description as a Trigger. |
| 8.3.2 | Return label. |

Flow then proceeds to box 540. In box 540, an intervention is selected (540). The intervention may be selected, for example, according to Table 1. The intervention is then performed (542). The intervention may be performed, for example, via a channel selected according to Table 1.

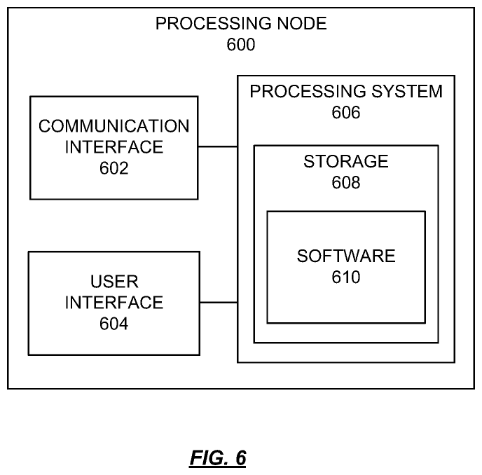

FIG. 6 illustrates an exemplary processing node 600 comprising communication interface 602, user interface 604, and processing system 606 in communication with communication interface 602 and user interface 604. Processing node 600 is capable of paging a wireless device. Processing system 606 includes storage 608, which can comprise a disk drive, flash drive, memory circuitry, or other memory device. Storage 608 can store software 610 which is used in the operation of the processing node 600. Storage 608 may include a disk drive, flash drive, data storage circuitry, or some other memory apparatus. Software 610 may include computer programs, firmware, or some other form of machine-readable instructions, including an operating system, utilities, drivers, network interfaces, applications, or some other type of software. Processing system 606 may include a microprocessor and other circuitry to retrieve and execute software 610 from storage 608. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600.

An example use of processing node 600 includes implementing intervention system 100, content classifier 110, user persona classifier 120, intervention mapping system 130, messaging module 131, intervention communication channels 132, data management system 140, platform interaction 150, their components, and/or implementing the methods described herein (e.g., the processes described herein with reference to FIGS. 2-5.) Processing node 500 can also be an adjunct or component of a network element.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of selecting an intervention, comprising:
based on user content submitted to a platform, determining whether the content includes objectionable content;
based on the objectionable content, associating a content persona classification with the objectionable content; and
based on the content persona classification, selecting an intervention.

2. The method of claim 1, wherein determining whether the content includes objectionable content includes determining a validity classification based on the user content.

3. The method of claim 2, wherein the objectionable content includes at least one trigger classification associated with user content that meets a threshold criteria indicating the user content is likely to elicit second user content that includes objectionable content.

4. The method of claim 1, wherein the user content includes user text and a user rating and the associating a content persona classification includes determining whether the user content and the user rating concur.

5. The method of claim 1, wherein the user content includes at least one of geography information, seller information, and product information, and the associating a content persona classification includes determining whether a subject of the user content and the at least one of geography information, seller information, and product information are in agreement.

6. The method of claim 1, wherein the user submitting the user content is associated with one of a plurality of roles related to a subject of the content.

7. The method of claim 6, wherein the plurality of roles include being a seller of the subject of the content.

8. The method of claim 6, wherein the plurality of roles includes purporting to be a buyer of the subject of the content.

9. A method, comprising:
receiving user content submitted to a platform;
determining whether the user content is associated with a product or is associated with a review;
associating a persona classification with the user content;
determining whether the user content includes objectionable content; and
based on the persona classification, the objectionable content, and whether the user content is associated with a product, selecting an intervention.

10. The method of claim 9, wherein determining whether the user content includes objectionable content includes determining a validity classification based on the user content.

11. The method of claim 10, wherein the objectionable content includes at least one trigger classification associated with user content that meets a threshold criteria indicating the user content is likely to elicit second user content that includes objectionable content.

12. The method of claim 9, wherein the user content includes user text and a user rating and the associating a content persona classification includes determining whether the user content and the user rating concur.

13. The method of claim 9, wherein the user content includes at least one of geography information, seller information, and product information, and the associating a content persona classification includes determining whether a subject of the user content and the at least one of geography information, seller information, and product information agree.

14. The method of claim 9, wherein the user submitting the user content is associated with one of a plurality of roles related to a subject of the content.

15. The method of claim 14, wherein the plurality of roles include being a seller of the subject of the user content.

16. The method of claim 14, wherein the plurality of roles includes purporting to be a buyer of the subject of the user content.

17. A method, comprising:
receiving user content associated with a product;
associating, with one or more of a set of classifications, the user content based on at least a set of defined personas, objectionability, and validity; and
based on the one or more of the set of classifications that the user content is associated with, selecting an intervention.

18. The method of claim 17, wherein the objectionability of the user content is based on at least one trigger classification associated with user content that meets a threshold criteria indicating the user content is likely to elicit second user content that includes objectionable content.

19. The method of claim 17, wherein the user content includes user text and a user rating and the associating with one or more of a set of classifications includes determining whether the user content and the user rating concur.

20. The method of claim 17, further comprising:
associating the user content with one of a plurality of a roles related to a subject of the user content.
